(19) United States
(12) Patent Application Publication
(10) Pub. No.: US 2016/0167516 A1
(43) Pub. Date: Jun. 16, 2016

(54) Method and Apparatus for Infotainment System Control Through a Wireless Device Operating-System-Independent Protocol

(71) Applicant: Ford Global Technologies, LLC, Dearborn, MI (US)

(72) Inventors: Basavaraj Tonshal, Northville, MI (US); Yifan CHEN, Ann Arbor, MI (US); Pramita Mitra, Southfield, MI (US); Jayanthi RAO, West Bloomfield, MI (US)

(21) Appl. No.: 15/047,751

(22) Filed: Feb. 19, 2016

Related U.S. Application Data
(62) Division of application No. 14/472,578, filed on Aug. 29, 2014.

(51) Int. Cl. B60K 35/00; H04L 29/08

(52) U.S. Cl. CPC B60K 35/00; H04L 67/025; B60K 2350/352

(57) ABSTRACT

A system includes a wireless device processor configured to communicate wirelessly with a remote vehicle infotainment system. The processor is also configured to receive web-based control display instructions from the vehicle infotainment system. The processor is further configured to display, in a web-browser, a vehicle infotainment control interface, in accordance with the display instructions. The processor is also configured to receive vehicle infotainment control instructions through the interface and submit a request to control the vehicle infotainment system in accordance with the received control instructions.

### CROSS-REFERENCE TO RELATED APPLICATIONS

This application is a division of U.S. application Ser. No. 14/472,578 filed Aug. 29, 2014, the disclosure of which is hereby incorporated in its entirety by reference herein.

### TECHNICAL FIELD

The illustrative embodiments generally relate to a method and apparatus for infotainment system control through a wireless device operating-system-independent protocol.

### BACKGROUND

Adoption of and adaptation to in-vehicle infotainment technology has been widely embraced by vehicle consumers to date. At the same time, advances in smart phone technology have made a significant impact on consumer lifestyle both in and outside vehicle environments. A seamless fusion of technologies inside and outside vehicles provides even greater opportunities for automotive owner experiences in areas including, but not limited to, convenience, empowerment, safety and value.

U.S. Pat. No. 8,621,483 generally relates to an apparatus for providing one or more applications to an in-vehicle infotainment (IVI) client device(s) that may include a processor and memory storing executable computer code causing the apparatus to at least perform operations including providing an application(s) and associated data to a device in response to receipt of an indication of a selection associated with the application(s). The computer program code may further cause the apparatus to enable the application(s) to access requested data via a plurality of application programming interfaces during execution of the application. The computer program code may further cause the apparatus to provide the requested data to the application in response to receipt of a message(s) generated by a first application programming interface of the interfaces that received a request for the requested data from a second application programming interface of the interfaces.

U.S. Patent Application 2014/0068713 generally relates to network communications, Web-based services and customized services using Web-based services that may be provided to drivers and users via an automobile head unit in a vehicle and via mobile devices. The automobile head unit in the vehicle and the mobile device are communicatively linked via a short range wireless connection. Also, these devices may communicate over a network such as a cellular network to a service provider that provides entertainment and informational services to the mobile device and the head unit of the vehicle. The user's profile and preferences are able to follow the user to various locations and into vehicles because this information is stored at a server accessible by the user's mobile device, and in some embodiments, also the head unit. The mobile device may provide services to the head unit if it does not have wider network connectivity over the short range wireless connection.

### SUMMARY

In a first illustrative embodiment, a system includes a processor configured to receive a request to control a vehicle infotainment system feature from a web-browser based access to a vehicle infotainment system. The processor is further configured to present the request to a driver. Also, the processor is configured to receive driver approval for a requesting device originating the request to control the infotainment system feature and authorize the requesting device to control the infotainment system feature using a web-browser based access to the infotainment system.

In a second illustrative embodiment, a computer-implemented method includes receiving a request to control a vehicle infotainment system feature from a web-browser based access to a vehicle infotainment system. The method also includes presenting the request to a driver and receiving driver approval for a requesting device originating the request to control the infotainment system feature. Further, the method includes authorizing, via a vehicle computing system, the requesting device to control the infotainment system feature using a web-browser based access to the infotainment system.

In a third illustrative embodiment, a system includes a wireless-device processor configured to communicate wirelessly with a remote vehicle infotainment system. The processor is also configured to receive web-based control display instructions from the vehicle infotainment system. Further, the processor is configured to display, in a web-browser, a vehicle infotainment control interface, in accordance with the display instructions. The processor is additionally configured to receive vehicle infotainment control instructions through the interface and submit a request to control the vehicle infotainment system in accordance with the received control instructions.

### BRIEF DESCRIPTION OF THE DRAWINGS

FIG. 1 shows an illustrative vehicle computing system;

FIGS. 2A and 2B show illustrative examples of control approval and provision processes;

FIG. 3 shows an illustrative architecture for vehicle control through brought in device browsers; and

FIG. 4 shows an illustrative process for interaction between various systems effecting vehicle process control.

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art to variously employ the present invention.

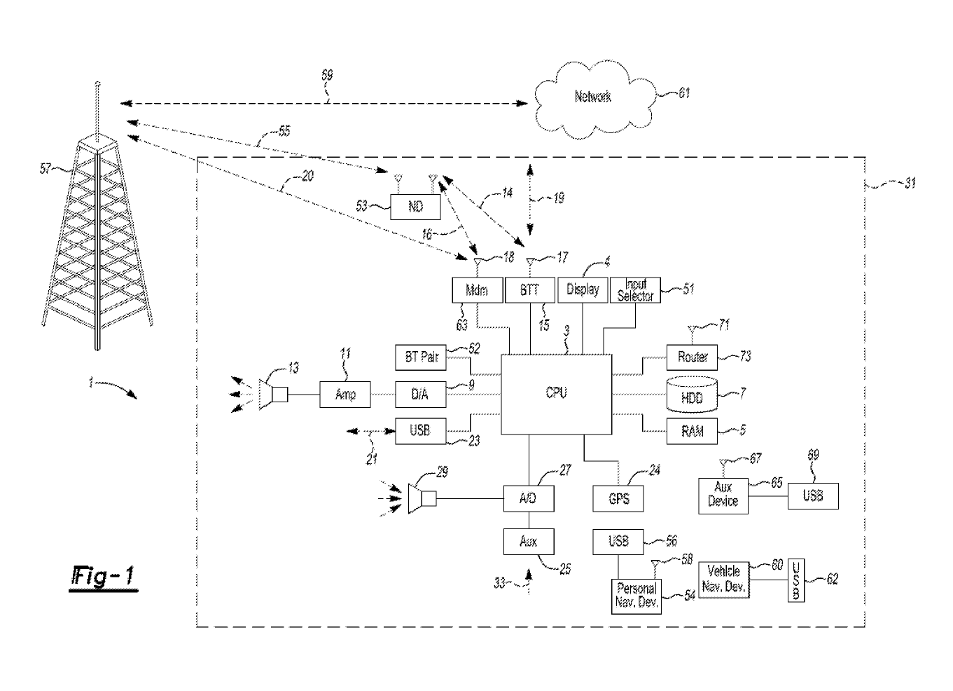

FIG. 1 illustrates an example block topology for a vehicle based computing system 1 (VCS) for a vehicle 31. An example of such a vehicle-based computing system 1 is the SYNC system manufactured by THE FORD MOTOR COMPANY. A vehicle enabled with a vehicle-based computing system may contain a visual front end interface 4 located in the vehicle. The user may also be able to interact with the interface if it is provided, for example, with a touch sensitive screen. In another illustrative embodiment, the interaction occurs through, button presses, spoken dialog system with automatic speech recognition and speech synthesis.

In the illustrative embodiment 1 shown in FIG. 1, a processor 3 controls at least some portion of the operation of the vehicle-based computing system. Provided within the vehicle, the processor allows onboard processing of commands and routines. Further, the processor is connected to both non-persistent 5 and persistent storage 7. In this illustrative embodiment, the non-persistent storage is random access memory (RAM) and the persistent storage is a hard disk drive (HDD) or flash memory. In general, persistent (non-transitory) memory can include all forms of memory that maintain data when a computer or other device is powered down. These include, but are not limited to, HDDs, CDs, DVDs, magnetic tapes, solid state drives, portable USB drives and any other suitable form of persistent memory.

The processor is also provided with a number of different inputs allowing the user to interface with the processor. In this illustrative embodiment, a microphone 29, an auxiliary input 25 (for input 33), a USB input 23, a GPS input 24, screen 4, which may be a touch screen display, and a BLUETOOTH input 15 are all provided. An input selector 51 is also provided, to allow a user to swap between various inputs. Input to both the microphone and the auxiliary connector is converted from analog to digital by a converter 27 before being passed to the processor. Although not shown, numerous of the vehicle components and auxiliary components in communication with the VCS may use a vehicle network (such as, but not limited to, a CAN bus) to pass data to and from the VCS (or components thereof).

Outputs to the system can include, but are not limited to, a visual display 4 and a speaker 13 or stereo system output. The speaker is connected to an amplifier 11 and receives its signal from the processor 3 through a digital-to-analog converter 9. Output can also be made to a remote BLUETOOTH device such as PND 54 or a USB device such as vehicle navigation device 60 along the bi-directional data streams shown at 19 and 21 respectively.

In one illustrative embodiment, the system 1 uses the BLUETOOTH transceiver 15 to communicate 17 with a user's nomadic device 53 (e.g., cell phone, smart phone, PDA, or any other device having wireless remote network connectivity). The nomadic device can then be used to communicate 59 with a network 61 outside the vehicle 31 through, for example, communication 55 with a cellular tower 57. In some embodiments, tower 57 may be a Wi-Fi access point.

Exemplary communication between the nomadic device and the BLUETOOTH transceiver is represented by signal 14.

Pairing a nomadic device 53 and the BLUETOOTH transceiver 15 can be instructed through a button 52 or similar input. Accordingly, the CPU is instructed that the onboard BLUETOOTH transceiver will be paired with a BLUETOOTH transceiver in a nomadic device.

Data may be communicated between CPU 3 and network 61 utilizing, for example, a data-plan, data over voice, or DTMF tones associated with nomadic device 53. Alternatively, it may be desirable to include an onboard modem 63 having antenna 18 in order to communicate 16 data between CPU 3 and network 61 over the voice band. The nomadic device 53 can then be used to communicate 59 with a network 61 outside the vehicle 31 through, for example, communication 55 with a cellular tower 57. In some embodiments, the modem 63 may establish communication 20 with the tower 57 for communicating with network 61. As a non-limiting example, modem 63 may be a USB cellular modem and communication 20 may be cellular communication.

In one illustrative embodiment, the processor is provided with an operating system including an API to communicate with modem application software. The modem application software may access an embedded module or firmware on the BLUETOOTH transceiver to complete wireless communication with a remote BLUETOOTH transceiver (such as that found in a nomadic device). Bluetooth is a subset of the IEEE 802 PAN (personal area network) protocols. IEEE 802 LAN (local area network) protocols include Wi-Fi and have considerable cross-functionality with IEEE 802 PAN. Both are suitable for wireless communication within a vehicle. Another communication means that can be used in this realm is free-space optical communication (such as IrDA) and non-standardized consumer IR protocols.

In another embodiment, nomadic device 53 includes a modem for voice band or broadband data communication. In the data-over-voice embodiment, a technique known as frequency division multiplexing may be implemented when the owner of the nomadic device can talk over the device while data is being transferred. At other times, when the owner is not using the device, the data transfer can use the whole bandwidth (300 Hz to 3.4 kHz in one example). While frequency division multiplexing may be common for analog cellular communication between the vehicle and the internet, and is still used, it has been largely replaced by hybrids of Code Domain Multiple Access (CDMA), Time Domain Multiple Access (TDMA), Space-Domain Multiple Access (SDMA) for digital cellular communication. These are all ITU IMT-2000 (3G) compliant standards and offer data rates up to 2 mbs for stationary or walking users and 385 kbs for users in a moving vehicle. 3G standards are now being replaced by IMT-Advanced (4G) which offers 100 mbs for users in a vehicle and 1 gbs for stationary users. If the user has a data-plan associated with the nomadic device, it is possible that the data-plan allows for broad-band transmission and the system could use a much wider bandwidth (speeding up data transfer). In still another embodiment, nomadic device 53 is replaced with a cellular communication device (not shown) that is installed to vehicle 31. In yet another embodiment, the ND 53 may be a wireless local area network (LAN) device capable of communication over, for example (and without limitation), an 802.11g network (i.e., WiFi) or a WiMax network.

In one embodiment, incoming data can be passed through the nomadic device via a data-over-voice or data-plan, through the onboard BLUETOOTH transceiver and into the vehicle's internal processor 3. In the case of certain temporary data, for example, the data can be stored on the HDD or other storage media 7 until such time as the data is no longer needed.

Additional sources that may interface with the vehicle include a personal navigation device 54, having, for example, a USB connection 56 and/or an antenna 58, a vehicle navigation device 60 having a USB 62 or other connection, an onboard GPS device 24, or remote navigation system (not shown) having connectivity to network 61. USB is one of a class of serial networking protocols. IEEE 1394 (FireWire™ (Apple), i.LINK™ (Sony), and Lynx™ (Texas Instruments)), EIA (Electronics Industry Association) serial protocols, IEEE 1284 (Centronics Port), S/PDIF (Sony/Philips Digital Interconnect Format) and USB-IF (USB Implementers Forum) form the backbone of the device-device serial standards. Most of the protocols can be implemented for either electrical or optical communication.

Further, the CPU could be in communication with a variety of other auxiliary devices 65. These devices can be connected through a wireless 67 or wired 69 connection. Auxiliary device 65 may include, but are not limited to, personal media players, wireless health devices, portable computers, and the like.

Also, or alternatively, the CPU could be connected to a vehicle based wireless router 73, using for example a WiFi (IEEE 803.11) 71 transceiver. This could allow the CPU to connect to remote networks in range of the local router 73.

In addition to having exemplary processes executed by a vehicle computing system located in a vehicle, in certain embodiments, the exemplary processes may be executed by a computing system in communication with a vehicle computing system. Such a system may include, but is not limited to, a wireless device (e.g., and without limitation, a mobile phone) or a remote computing system (e.g., and without limitation, a server) connected through the wireless device. Collectively, such systems may be referred to as vehicle associated computing systems (VACS). In certain embodiments particular components of the VACS may perform particular portions of a process depending on the particular implementation of the system. By way of example and not limitation, if a process has a step of sending or receiving information with a paired wireless device, then it is likely that the wireless device is not performing the process, since the wireless device would not “send and receive” information with itself. One of ordinary skill in the art will understand when it is inappropriate to apply a particular VACS to a given solution. In all solutions, it is contemplated that at least the vehicle computing system (VCS) located within the vehicle itself is capable of performing the exemplary processes.

In each of the illustrative embodiments discussed herein, an exemplary, non-limiting example of a process performable by a computing system is shown. With respect to each process, it is possible for the computing system executing the process to become, for the limited purpose of executing the process, configured as a special purpose processor to perform the process. All processes need not be performed in their entirety, and are understood to be examples of types of processes that may be performed to achieve elements of the invention. Additional steps may be added or removed from the exemplary processes as desired.

The illustrative embodiments relate to a novel software architecture based on modern web standards, which allows for a seamless integration of a brought-in device (e.g., smartphone) with a cockpit infotainment system. Through use of standard web browsers on brought-in devices, remote control of in-vehicle infotainment is enabled, allowing control and customization of vehicle systems on almost any brought-in device, without having to customize an interface for that specific device.

Generally, in-vehicle infotainment systems focus on providing drivers with the capability to control functions in an easy and safe manner. There are many features and functions of the vehicle system, however, that passengers (i.e. non-drivers) may desire to control. Allowing these non-drivers to easily control these systems using brought-in devices will enhance and enrich the driving experience for all involved, and will bring a measure of safety by not requiring a driver, whose attention is better focused on the road, to adjust the system(s). By utilizing a device browser, which has a common, standard protocol across various devices, control can be presented for use by a variety of devices without having to ensure precise compatibility with a specific device protocol or architecture.

There are a number of features that would be appropriate for non-driver control, including, but not limited to, passenger climate control, rear climate control, infotainment control, ambient lighting, and navigation control.

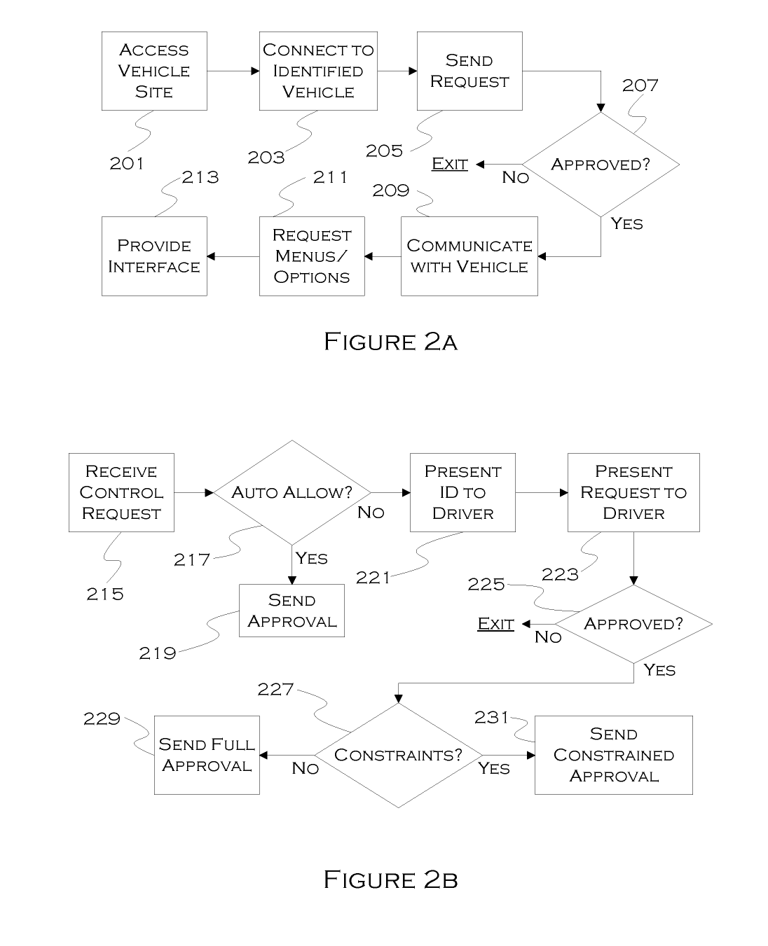

In FIG. 2A, the process is shown from a brought-in device perspective. This is an illustrative process for the brought-in device to connect to and request control from the vehicle computing system in the vehicle in which the device is traveling. In this example, the process first attempts to access a vehicle website 201. This can be a site defined on a local network for a vehicle, in a similar manner that a router may be commonly accessed by input of a common router-address.

This will allow direct control of the vehicle through the local address, once the request has been approved.

With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

Once the device has had the site address input, the device can connect to the vehicle identified by the local web address 203. This will give basic connectivity, but, in this example, the request may still need to be approved before actual control will be provided.

A request for actual control of a vehicle system may be sent to the vehicle computer 205. This can include, for example, a password for the specific vehicle, if the specific vehicle requires a password for allowing control. In other examples, all requests to access the system may be approved by default. Since many vehicles may be driving in close proximity, however, it may be the case that some authentication is desired before allowing control of the vehicle systems. For similar reasons, some version of a vehicle-specific web identifier may be used to access the website relating to a certain vehicle. Or, a device may be required to be connected to a vehicle wireless network before allowing access to the specific website relating to the specific vehicle.

Once a device has been approved for in-vehicle control, the device may communicate with a vehicle server responsible for event handling within the vehicle 209. The device may request a menu with options for vehicle control 211, and once the menu has been received, the device may present the menu to the user as a usable interface for in-vehicle control 213, via the vehicle's web browser.

FIG. 2B shows an illustrative example of the authentication process from the vehicle-side. In this example, the process receives a control request from a connected device 215. If the driver has the system set to auto-allow devices 217, the process may send an approval 219 to the device, allowing control.

If driver authentication is required, the process may present a device ID to the driver 221, as well as presenting a request to the driver for full or limited control 223. If the request is not approved, the process may exit. If the request is approved by the driver 225, the process may determine if any constraints are to be implemented 227. For example, a driver may give limited approval to change climate controls, but may deny the capabilities to change infotainment (e.g., radio station) settings.

If constraints are required 227, the process may send an approval that includes limiting functionality based on constraints 231. If there are no constraints required, the process may send a full approval to the requesting device, that allows use of the vehicle systems without constraint 229.

With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

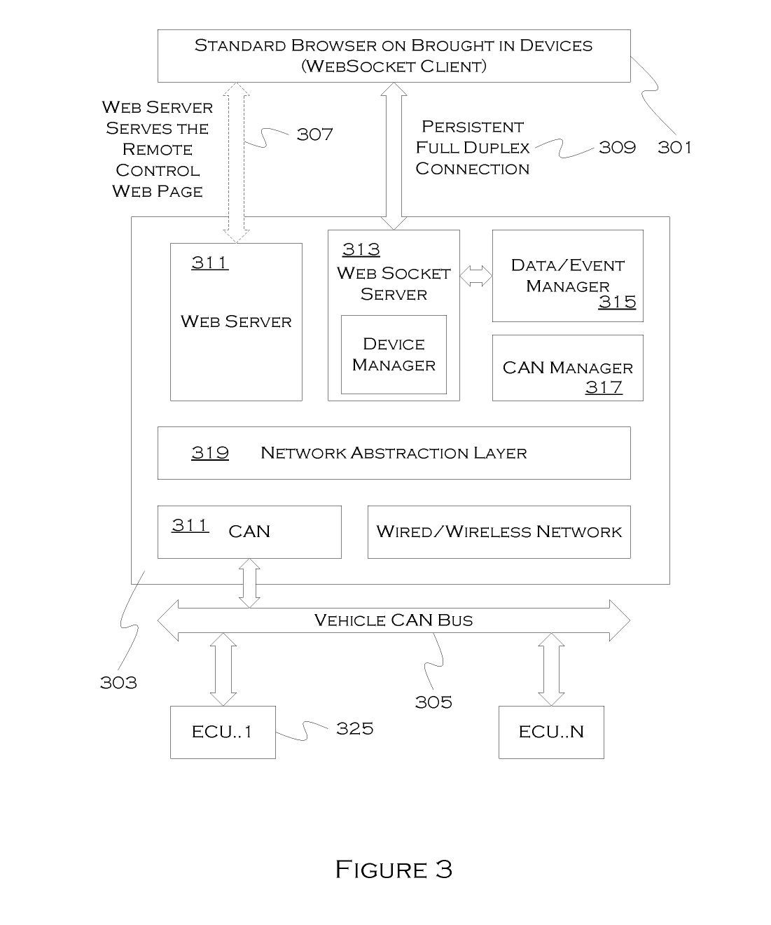

FIG. 3 shows an illustrative architecture for non-driver control of in-vehicle infotainment systems. In this example, a brought-in device utilizes a standard web browser 301. In between the vehicle systems and the brought-in device exists an Accessory Protocol Interface Module (APIM) 303, that handles requests from the client(s), authentication, and any events that pass to or from the device(s). With respect to the illustrative embodiments described in this figure, it is noted that a general purpose processor may be temporarily enabled as a special purpose processor for the purpose of executing some or all of the exemplary methods shown herein. When executing code providing instructions to perform some or all steps of the method, the processor may be temporarily repurposed as a special purpose processor, until such time as the method is completed. In another example, to the extent appropriate, firmware acting in accordance with a preconfigured processor may cause the processor to act as a special purpose processor provided for the purpose of performing the method or some reasonable variation thereof.

The APIM includes a web server 311 that serves the remote control webpage (which is the interface on the brought-in device). The process also includes a web socket server 313 that maintains a connection 309 (a full duplex connection in this example) with the remote/brought-in device. The socket server also serves as a device manager for connected devices and a data/event manager 315 for requests from the various devices and vehicle systems.

The APIM also includes a CAN manager 317, for managing requests to and from the CAN bus or other vehicle network(s). Also included is a network abstraction layer 319, a CAN connection 321, and a wired/wireless connection handling sub-process 323.

The APIM interfaces with the vehicle system through one or more vehicle networks, such as a CAN network 305. The CAN network connects to, and passes information to and from the various independent vehicle modules 325.

By utilizing an architecture as described herein, there is no need to install any particular application on any brought in device. As long as the device has a standard browser, the device is ready for control. Also, this architecture offers a high scalable, cross OS platform solution using a variety of brought in devices. Further, this provides for brought in device remote control across vehicle platforms and model options that have no rear seat screen or other rear control option(s).

Communication between the client and the APIM module is enabled by secure wireless/wired links provided by any wireless/wired technology that supports point to multipoint communication capability, such as, but not limited to, Bluetooth, Wi-Fi, cellular, etc.

The web-server may be responsible for hosting and serving control web resources to the clients. The web-socket-server may be responsible for resolving simultaneous access requests from multiple clients and synchronous updating of the UI on multiple clients (e.g., updating changes to a system state without a refresh request).

The device manager module will be the module responsible for managing multiple remote control devices, to that end, thus module will handle decisions such as how many remote control devices can be simultaneously active in the cockpit and who can have remote control access to the in-vehicle system when more than one passenger requests access. Access can be granted under any suitable protocol, for example, such as prioritized by user (parent requests trump child requests), first in first out, etc.

In an illustrative example, Bob (driver) and Alice and Carol (passengers) have entered a vehicle and are preparing for a trip. Once Bob has activated the vehicle, Alice and Carol can launch their web browsers and request connection to and control of the infotainment system(s). Bob can then approve or deny the requests. Assuming the requests are approved, the browsers on each connected mobile device render a control screen for the vehicle, allowing the device owners (Alice and Carol) to control the vehicle systems from the device browsers.

Simultaneous requests from Alice and Carol will be handled according to the appropriate paradigm. Since the system can tailor the interface, features to which Alice or Carol may not be granted access may either be grayed out or not presented all together.

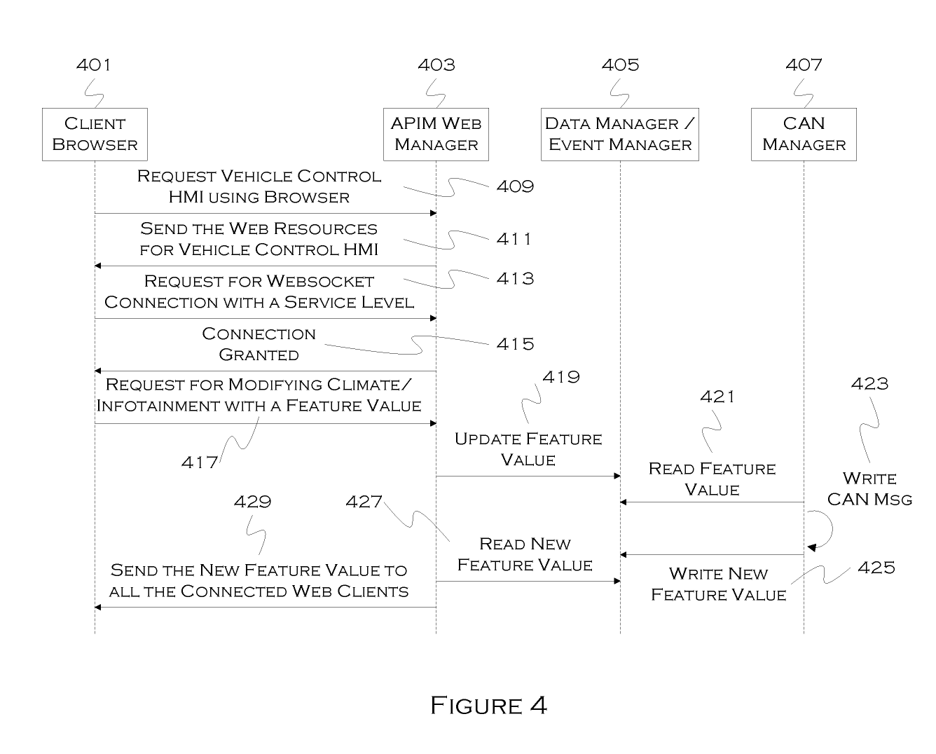

FIG. 4 shows an illustrative example of module interaction detailing an exemplary process for control of the vehicle systems through non-driver remote control.

In this illustrative example, the non-driver utilizes a device running a browser 401. This browser is connected to an APIM web manager module 403. The non-driver requests vehicle control using an HMI browser 409. This is the initial connection request to obtain control over the vehicle server and is sent from the browser to the APIM web manager.

In response to the request, the process sends an HMI including web resources for vehicle control 411 from the web manager to the client browser. At this point, the browser sends a request for web socket connection with a service level 413 and waits for the connection to be granted 415.

Once the connection and a requested service level have been granted, the process waits until a request to modify a parameter of the system is originated 417 at the client browser 401. The request, in this example, includes a feature value (e.g., a change in the feature level to the new value) 419, which is propagated to the event manager 405.

The event manager 405 reads a current feature value from the CAN bus 421, which is passed to the CAN manager 407. A CAN message is then written to the BUS 423, from where the system can update the vehicle systems with the new value (e.g., changing the current value of the appropriate system). This new feature value can then be written to the data manager 425, so that the value is correct in the data manager following the new setting. The new feature value is then read by the APIM web manager module 427, which can send the new feature value to all the connected web clients 429, thus updating the web clients with the appropriate values.

While exemplary embodiments are described above, it is not intended that these embodiments describe all possible forms of the invention. Rather, the words used in the specification are words of description rather than limitation, and it is understood that various changes may be made without departing from the spirit and scope of the invention. Additionally, the features of various implementing embodiments may be combined to form further embodiments of the invention.

What is claimed is:

1. A system comprising:
a wireless device processor configured to:
communicate wirelessly with a remote vehicle infotainment system;
receive web-based control display instructions from the vehicle infotainment system;
display, in a web browser, a vehicle infotainment control interface in accordance with the display instructions;
receive vehicle infotainment control instructions through the interface; and
submit a request to control the vehicle infotainment system in accordance with the received control instructions.

2. The system of claim 1, wherein the control interface replicates a control interface displayed on a vehicle display.

3. The system of claim 1, wherein the processor is configured to submit a control authorization request prior to display of the control interface.

4. The system of claim 1, wherein the control interface displays a limited number of controllable vehicle infotainment features in accordance with permissions assigned to a device including the wireless device processor.

5. The system of claim 1, wherein the request to control the infotainment system in accordance with the received control instructions includes a device identifier.

6. The system of claim 1, wherein communication between the wireless device and the infotainment system is facilitated utilizing a web-based protocol.

7. A computer-implemented method, executed by a portable device, comprising:
displaying, in a web browser, a vehicle infotainment control interface in accordance with display instructions received wirelessly from a vehicle infotainment system; and
transmitting a request to control the vehicle infotainment system in accordance with vehicle infotainment control instructions received through the vehicle infotainment control interface.

8. The method of claim 7, wherein the control interface replicates a control interface displayed on a vehicle display.

9. The method of claim 7, further comprising transmitting a control authorization request prior to display of the control interface.

10. The method of claim 7, wherein the control interface includes a limited number of controllable vehicle infotainment features in accordance with permissions assigned to the portable device.

11. The method of claim 7, wherein the request to control the infotainment system in accordance with the received control instructions includes a device identifier.

12. The method of claim 7, wherein communication between the portable device and the infotainment system includes communication utilizing a web-based protocol.

13. A non-transitory storage medium storing instructions that, when executed by a processor of a portable device, cause the portable device to perform a method comprising:
in response to receiving authorization from a vehicle infotainment system, displaying, in a web browser, controllable vehicle infotainment features in accordance with portable device permissions in an infotainment control interface; and
communicating web-based protocol requests to control the vehicle infotainment system based on input to the infotainment control interface.

14. The storage medium of claim 13, wherein the infotainment control interface replicates a control interface displayed on a vehicle display.

15. The storage medium of claim 13, the method further comprising receiving web-based instructions from the vehicle infotainment system.

16. The storage medium of claim 13, wherein the infotainment control interface displays a subset of controllable vehicle infotainment features based on the portable device permissions relative to features available on a control interface of a vehicle display.

17. The storage medium of claim 13, wherein the web-based protocol requests include a device identifier.

18. The storage medium of claim 13, wherein the infotainment control interface replicates a control interface of a vehicle display.
